(19) United States
(12) Patent Application Publication
(10) Pub. No.: US 2003/0223528 A1
(43) Pub. Date: Dec. 4, 2003

(54) Electrostatic accelerated-recirculating-ion fusion neutron/proton source

(76) Inventors: George Miley, Champaign, IL (US); Yibin Gu, Champaign, IL (US); Jalal B. Javedani, Kirkland AFB, NM (US)

Correspondence Address: Woodard, Emhardt, Naughton,, Moriarty and McNett LLP, Suite 3700, Bank One Center/Tower, 111 Monument Circle, Indianapolis, IN, 46204-5137, US

(21) Appl. No.: 10/364,898

(22) Filed: Feb. 12, 2003

Related U.S. Application Data
(63) Continuation of application No. 09/056,825, filed on Apr. 8, 1998, now abandoned.
Application No. 09/056,825 is a continuation-in-part of application No. 08/491,127, filed on Jun. 16, 1995, now abandoned.

(51) Int. Cl. G21J 1/00; G21B 1/00

(52) U.S. Cl. 376/113

(57) ABSTRACT

An electrostatic accelerated-recirculating-ion fusion neutron/proton source is disclosed. The device acts as a compact accelerator-plasma-target fusion neutron/proton source which can emulate a line-type source. The unit comprises an axially elongated hollow vacuum chamber having an inner and outer wall. Reflectors are located at opposite ends of the vacuum chamber so that their centers lie on the axis of the vacuum chamber. A cathode that is 100% transparent to oscillating particles is located within the vacuum chamber between the reflectors, defining a central volume and having the same axis as the vacuum chamber. Anodes that are 100% transparent to oscillating particles are located near opposite ends of the vacuum chamber between the reflectors dishes and the cathode, having axes coincident with the axis of the vacuum chamber. A means is also provided for introducing controlled amounts of reactive gas into the vacuum chamber, and its central volume. Further, a means is provided for applying an electric potential between said anodes and said cathode and said reflectors. This applied potential plus the electrode/reflector designs/spacings are such that ions are focused in a zone along the axis of the hollow cathode, creating a line-like neutron/proton source. Electrons are focused within the hollow anodes, creating the primary ion source there, while leaking electrons are reflected and refocused within the anodes by the concave reflector dishes. In an alternative embodiment, a means for generating a magnetic field in the axial direction is attached to the circumference of the vacuum chamber. The magnetic field enhances electrostatic confinement and focusing effects such as to reduce ion/electron diffusion losses and increase the fusion rate density in the reaction zone in the hollow cathode.

### BACKGROUND OF THE INVENTION

1. Field of the Invention

This invention relates to a particle generator, in particular, to an electrostatic accelerated-recirculating-ion fusion neutron/proton source (“neutron/proton source”) that confines controlled nuclear fusion reactions inside a negative potential well structure. The resulting invention is termed a “cylindrical inertial-electrostatic confinement” (IEC) device.

2. Description of the Prior Art

Prior experimental work has been done by several laboratories on IEC devices. These devices generate energetic particles (i.e., ions and electrons) and contain them within an electrostatic field. One such experimental study employed ion-gun injectors connected to a spherical IEC unit that demonstrated the ability to generate approximately 10⁹ D-T neutrons per second at maximum currents and voltages. These maximums were established by grid-cooling requirements and voltage breakdown limits. The ion guns employed special characteristics which are disclosed in U.S. Pat. No. 3,448,315 issued to R. L. Hirsch et al. The '315 patent discloses an improvement for forming and directing a beam of ions into an IEC chamber with increased efficiency.

U.S. Pat. No. 3,386,883, issued to P. T. Farnsworth, discloses ion guns mounted around a spherical anode that surrounds a spherical cathode. Ions from the guns are focused into the center of the cathode. U.S. Pat. No. 3,258,402, also issued to P. T. Farnsworth, is an earlier version of the same device that discloses a spherical cathode surrounding a spherical anode. This patent suggests that with a proper choice of materials for the cathode, the central gas may be ionized by electron emission from the cathode, thus eliminating the need for ion guns.

U.S. Pat. No. 3,530,497 issued to Hirsch et al., also illustrates a spherical anode, a concentrically positioned ion-source grid, and a cathode that is spherical and permeable to charted particle flow. However, both the spherical cathode and the ion-source grid are required, and the ion-source grid is placed between the cathode and the anode. Varying potentials are applied to each of the three electrodes, thus establishing a first electric field in the space between the anode and the ion-source grid and a second electric field in the space between the ion-source grid and the cathode, which is at a different potential than the first electric field. Ions formed inside the ion-source grid are propelled toward the centrally located cathode due to the potential difference. These ions are focused toward the center of the inside of the cathode where they interact, thereby producing a fusion reaction.

One disadvantage of this device is that it requires an ion-source grid in addition to the spherical cathode, anode and vacuum chamber. Furthermore, a thermionic cathode is required in the space between the outer anode and the ion-source grid, such that electrons from the thermionic cathode will flow toward the grid rather than to the outer anode. With the addition of each element, the complexity and cost of the apparatus increases.

The inventors named here participated in preparing papers entitled “Advantages of Inertial-Electrostatic Confinement Fusion,” published in Fusion Technology, 20, p. 850, December 1991 and “Characterization of an Inertial-Electrostatic Confinement Glow Discharge (IECGD) Neutron Generator,” published in Fusion Technology, 21, p. 1639, May 1992. These papers reported initiated studies that culminated in the invention of a spherical-type IEC device with some features of the Hirsch and Farnsworth device, but employing a novel internal ion generation to eliminate the complex and costly ion gun injection units. This new spherical IEC neutron/proton source is disclosed in patent application PCT/US95/05185, filed on Apr. 25, 1995.

Problems with the prior art IEC, such as the Hirsch/Farnsworth gun-injected units, include that they are expensive to manufacture, are bulky, and require precise alignment of components, such as ion guns, in order to operate properly. With these complications, their use was intended for higher-intensity applications, viewed as leading to a fusion energy source, which implies neutron emission rates above 10¹⁴ neutrons per second (“n/s”). Other applications, such as neutron activation analysis, require a compact lower-intensity source (i.e., about 10⁶ n/s), which is typically met using radioisotope neutron sources, e.g., Cf-252. However, disadvantages of such radioisotopes include their relatively short half-lives and the broad energy spectrum of their emitted neutrons. Another problem with the radioisotope design is that it does not have an on/off capability. Thus, the source must be stored in bulky protective shielding when not in use. Further, Cf-252 must be produced using a high-flux fission reactor, making it expensive and due to a reduction in such reactors operating in the U.S. in recent years, fairly scarce. Thus, there is a strong motivation to seek other types of neutron sources such as offered by the IEC concept, which in effect, provides a compact acceleration-plasma-target operation.

Also, for certain applications, a “line-like” neutron source is desired (vs a point-like source) to provide a broad surface coverage. All of the available sources such as radioisotopes on solid-target accelerator units imitate point sources. The prior spherical IEC units are also restricted to a point-source geometry. Consequently, the present invention uses a new cylindrical IEC geometry which offers considerable flexibility in neutron/proton source configuration, ranging from point to line-type source geometry. Further, the cylindrical geometry offers access to applications where the source is to be inserted in a pipe or a bore-hole.

In addition to neutrons, some applications such as proton emission isotope production require a high-energy proton source. The proton source most commonly used today is a large and expensive proton accelerator. Such devices could easily be replaced by a simpler, more compact IEC of the present invention using D-³He reactions to produce 14 MeV protons. Since fusion reactions in the device occur at an ion energy essentially equivalent to the voltage, the transition from D-D fusion to D-³He fusion is easily accomplished by replacing the fill gas of deuterium with a mixture of deuterium and D-³He. In the energy range of 60-90 keV, the fusion cross sections for the two reactions are roughly equivalent. Consequently, with operation in this voltage range, the D-³He fusion reaction rate will be roughly equivalent to the D-D rate. This feature is one of the advantages beam-induced fusion. Only the beam ions need to be accelerated to the desired energy, whereas in sharp contrast, for a thermalized fusion plasma such as used in a toroidal magnetic system or a mirror system, the entire volume of ions contained in the plasm must be heated to an equivalent high temperature.

Several prior inventions have been designed to achieve beam-beam fusion reactions by controlling and directing ion beams. J. Blewett (U.S. Pat. No. 5,034,183, Jul. 23, 1991, titled “Apparatus for Colliding Nuclear Particle Beams Using Ring Magnets) and B. Maglich and S. Menasian (U.S. Pat. No. 4,788,024, Nov. 29, 1988, titled Apparatus and Method for Obtaining a Self-Colliding Beam . . . ”) accomplish this by using a specially designed magnetic field to curve ion beams such that they continually recirculate and collide at a point in the center of the configuration. Electrons are added in an attempt to prevent excessive space charge buildup at the ion intersection point. In contrast, the present invention uses electrostatic fields for recirculation and focusing of the ions along a line-like volume within a hollow cathode. This configuration relaxes focusing requirements and makes an expanded volume possible. In addition, electrons are self-consistently controlled as part of the electrostatic field design and as an inherent part of the beam-plasma developed in the contained volume. This alleviates space charge problems and allows higher ion densities. Further, due to the presence of the background plasma and neutral ions, beam ion-background ion reactions are obtained as well as beam-beam reactions. This combined beam-beam and beam-background enhances that reaction rate density and also extends the useful operational range to lower beam currents. In summary then, the present invention uses a unique electrostatic configuration to obtain a versatile beam-beam and beam-background reaction regime, including the capability of a line-like source, not available with the prior magnetic-type colliding beam inventions.

Other concepts for colliding beams or for focusing ion beams on a restive target such as A Maschke's disclosure (U.S. Pat. No. 4,350,927, Sep. 21, 1982, titled “Means for the Focusing and Acceleration of Parallel Beams of Charged Particles”) rely on a linear configuration of single or multiple beams. Reactions are generally achieved by focusing the beams on a target, the beam intensity being increased during focusing. This approach is much less efficient than recirculating ion beam devices such as the present invention, because ions failing to react do not have a “second chance” as provided by recirculation.

Further, the present invention offers a unique long-lived plasma target that is a self-consistent feature of the configuration. Also, as noted above, the present invention controls space charge effects self-consistently through confinement and focusing of electrons from the background plasma. These unique features offer, then, the added advantages of conj?????, extended lifetime, and improved energy efficiency.

Other prior inventions such as those by R. Hirsch (U.S. Pat. No. 3,605,508, Apr. 11, 1972, titled ‘electrostatic Field Apparatus for Reducing Leakage of Plasma from Magnetic Type Fusion Reactors”) and by S. C. Jardine et al. (U.S. Pat. No. 4,436,693, Mar. 13, 1984, titled “Method and Apparatus for the Formation of a Spheromak Plasma) employ electrostatic fields to assist magnetic confinement of a fusing plasma. Hirsch's device reduces leakage from the ends of a magnetic mirror confinement device. Jardine et al. employ electrostatic fields in combination with magnetic fields in the formation of a toroidial-type magnetically confined focusing plasma termed the “spheromak.” These inventions are quite different from the present one, relying on magnetic confinement and on a reacting plasma without beam involvement. The features of beam reactions, beam focusing, and recirculation provided by the present unique electrostatic configuration provide important advantages of compactness and energy efficiency not possible with magnetic confinement. As an illustration, small portable units based on the present invention are under development for neutron activation sources. Magnetic confinement sources would involve many larger, centrally located facilities.

Another approach to ion beam-type reactions has been disclosed by R. W. Bussard in U.S. Pat. Nos. 4,826,646 Mary 2, 1989 (“Method and Apparatus for Controlling Charged Particles”) and 5,160,695, Nov. 3, 1992 (“Method and Apparatus for Creating and Controlling Charged Particles”). These concepts are important variations on the Farnsworth and Hirsch spherical IEC devices noted earlier. In the first, ion acoustic waves are employed as a collision-diffusion compressional enhancement process in the IEC configuration. In the second patent, a spherical-like magnetic field is added to the internal electrostatic fields of the IEC configuration in order to eliminate the need for grids. Neither of these concepts, like the original Farnsworth/Hirsch spherical IEC, offers the versatility of a line-like source or cylindrical geometry such as achieved by the present invention. In addition, the beam control and focusing techniques plus self-consistent electron confinement for the present invention uses entirely different principles compared to the prior spherical IEC art.

Another alternate low-intensity neutron source uses a miniature deuteron accelerator to bombard a solid target coated with tritium. (R. C. Smith et al., IEEE Trans. on Nuc. Sci, 35, 1, 859 [1988]). Currently available, small (i.e., 10⁶-10⁸ n/s) neutron generators of this type use a titanium target impregnated with deuterium or a deuterium-tritium mixture. The device typically operates in a short-pulse mode with a moderate repetition rate in order to avoid overheating of the target. Target lifetimes are limited by sputtering and degassing during operation. Versions of this concept with higher neutron intensities have been built using a high-speed rotating target to prevent overheating and reduce erosion, but these devices are very expensive.

These accelerator-solid target generators have many disadvantages. For instance, they do not operate very long before maintenance becomes necessary. Because they use tritiated targets, the user must comply with radioisotope-handling regulations. Furthermore, the target's effectiveness typically decreases with time due to the desorption of tritium during direct bombardment by high-energy ions. The target is ultimately exhausted and must be replaced at considerable expense, after only several hundred hours of operation. Also, the decay of tritium leads to a buildup of ³He gas pressure in the target material, resulting in spallation of the surface. Moreover, the internal surface of the generator eventually becomes contaminated by titanium particles that sputter off the target due to ion bombardment. This contamination reduces the effective insulation of the walls of the device, leading to arcing. This type of generator also has the storage and disposal problems associated with radioisotope sources.

The present invention is intended to overcome many of the disadvantages of these various neutron/proton sources, and at the same time, extend the geometry to a cylindrical unit with a line-type neutron/proton source.

### SUMMARY OF THE INVENTION

According to the present invention, an electrostatic accelerated-recirculating-ion fusion neutron/proton source is provided, comprising and axially elongated hollow vacuum chamber having an inner and outer wall. Reflectors are located at opposite ends of the vacuum chamber so that their centers lie on the axis of the vacuum chamber. A cathode that is 100% transparent to oscillating particles is located within the vacuum chamber between the reflectors, defining a central volume and having the same axis as the vacuum chamber. Anodes that are 100% transparent to oscillating particles are located near opposite ends of the vacuum chamber between the reflectors and the cathode, having axes coincident with the axis of the vacuum chamber. A means is also provided for introducing controlled amounts of reactive gas into the vacuum chamber, and its central volume. Further, a means is provided for applying an electric potential between said anodes and said cathode and to produce ions from the reactive gas within the central volume and to cause the recirculation of these ions within the vacuum chamber. This recirculation of ions is enabled by axial confinement due to the anodes, which decelerate and reflect ions approaching the ends of the unit while the inertia of the energetic provides radial confinement. Hence, ion confinement and recirculation is further improved by designing the electrode ion optics such that the ions are contained in trajectories forming an ion beam or channel along the axis. Reflecting dishes on the ends electrostatically repel electrons so as to prevent their axial leakage which could cause space charge effects that would disrupt the ion confinement.

In an alternative embodiment, a means for generating a magnetic field in the axial direction is attached to the circumference of the vacuum chamber in order to further enhance radial ion confinements. This version then provides hybrid electrostatic-magnetic confinement, whereas the primary version is purely electrostatic. The hybrid version differs from prior magnetic mirror devices equipped with electrostatic plugs (e.g., see Hirsch . . . ) in that the magnetic field is designed to reduce radial losses but not to reflect ions from the ends. In the electrostatic version, the anode still fulfills that function.

### OBJECTS OF THE INVENTION

It is an object to provide a neutron/proton source that can be switched on or off and which employs electrostatic axial ion confinement plus inertial radial ion confinement to provide effective recirculation of ions.

Another objective is to design the electrode ionoptics such that ions travel within trajectories forming ion beams along the device's axis.

Additional objectives are to:

Provide a neutron/proton source with a cathode that is 100% transparent to oscillating ions, thereby allowing high ion recirculation and eliminating ion-cathode collisions, which reduces ion losses and overheating and erosion of the cathode.

Provide a neutron/proton source that is simple in its operation and construction, sturdy in its design and is a low-cost fusion neutron/proton source.

Provide a neutron/proton source that is easily portable.

Provide a neutron/proton source that does not use a radioisotope neutron source.

Provide a neutron/proton source that does not use an accelerator-solid target design.

Provide a neutron/proton source that does not use a spherical design, thereby allowing for specialized applications of the neutron/proton source where an alternative geometry is of interest.

Provide a neutron/proton source with two anodes and two reflectors that creates positive potential wells, which allow electrons to oscillate within the potential wells, thereby reducing ion loss rate.

Provide a neutron/proton source with two anodes that are 100% transparent to oscillating particles, thereby allowing high particle recirculation and eliminating particle-anode collisions, which reduces particle losses, overheating, and erosion of the anodes.

Provide a neutron/proton source with good recirculatory ion beam focusing due to an electron microchanneling effect caused by hollow cylindrical anodes.

Provide a neutron/proton source with nearly isotropic angular distribution emitted along ion microchannels, to a first-approximation approaching an isotropic line source or point source, depending on the length of the cathode.

Provide a neutron/proton source that produces a plurality of dense ion beams, thereby causing a greater number of ion collisions, causing fusion reactions.

Provide an apparatus for generating a fusion reaction resulting in a neutron/proton source with a neutron generation rate proportional to the ion current a lower current (≦10 amp), becoming proportional to the square or higher power of the total recirculation ion-beam current at higher ≧10 amp) currents.

Achieve improved power efficiency by using a pulsed power supply, thereby providing an improved neutron yield per time averaged input power due to the current squared (or higher power) scaling of neutron yield.

Provide an apparatus that can produce 2.5 MeV neutrons from D-D reactions using deuterium gas and easily can be converted to produce 14 MeV neutrons from D-T reactions by using a mixture of deuterium and tritium gas (“D-T”).

Provide an apparatus that easily can be converted from producing neutrons to producing energetic protons by changing the gas from deuterium or a deuterium-tritium mixture, to a mixture of deuterium and Helium-3 (“D-³He”).

Provide a neutron/proton source with a magnetic field that confines particles in the radial direction, thereby reducing further the particle loss rate.

Other objects and advantages of the invention will become apparent upon reading the following detailed description and upon reference to the drawings. Throughout the drawings, like reference numerals refer to like parts.

### BRIEF DESCRIPTION OF THE DRAWINGS

FIG. 1 is a diagrammatic illustration of the neutron/proton source embodying the present invention.

FIG. 2 illustrates the use of electrode electrostatic optical properties to focus ions and electrons to form a localized ionization region in the vicinity of the anodes and a line-type fusion reaction region along the cathode axis.

FIG. 3 is a plot of ion trajectories calculated for the preferred electrode configuration.

FIG. 4 is a plot of ion trajectories for the case where the electrode diameter is reduced from 90 mm to 80 mm.

FIG. 5 is a plot of ion trajectories for the case where the electrode diameter is further reduced to 60 mm.

FIG. 6 is a diagram of the idealized negative and positive electric potential wells generated by the cylindrical cathode, cylindrical anodes and reflecting dishes.

FIG. 7 is a diagrammatic illustration of an alternate embodiment of the neutron/proton source having a plurality of magnetic rings.

FIG. 8 is a photograph of cylindrical device during steady-state operation.

FIG. 9 is a plot of the neutron yeild vs voltage during steady-state operation.

FIG. 10 shows the neutron yield as a function of distance alone axes of cylindrical device (final data point is high because of heating of bubble dosimeter).

FIG. 11 is a schematic diagram of the PFN pulsing circuit used for prototype pulsed experiments.

FIG. 12 is a diagram of the voltage pulse waveform from IEC line source pulse power unit.

### DESCRIPTION OF THE PREFERRED EMBODIMENT

While the invention will be described in connection with a preferred embodiment, it will be understood that it is not intended to limit the invention to this embodiment. On the contrary, it is intended to cover all alternatives, modifications and equivalents as may be included within the spirit and scope of the invention.

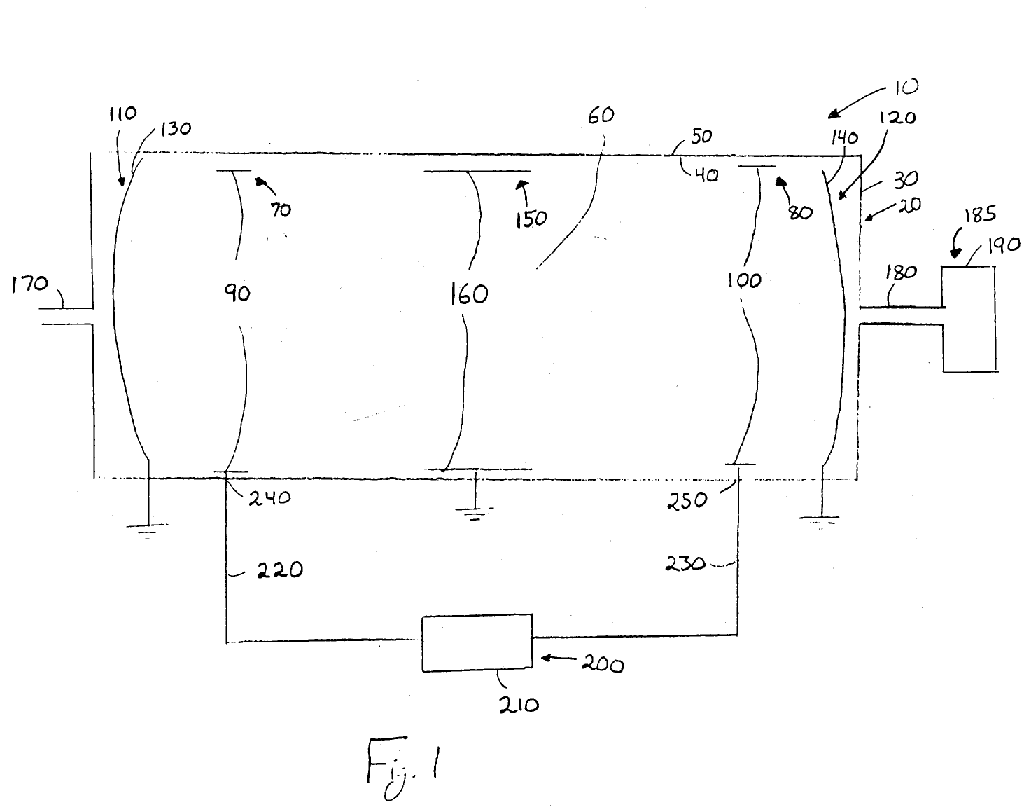

Turning first to FIG. 1, the portable electrostatic accelerated-recirculating-ion fusion neutron/proton source 10 of the present invention first comprises a hollow vacuum chamber 20. In the preferred embodiment, the hollow vacuum chamber 20 is a cylindrical vacuum chamber 30 having an inner wall 40 and an outer wall 50, and defining a central volume 60. The cylindrical vacuum chamber 30 is preferably made from an electrical insulator such as glass. However, other electrical insulators such as ceramics or metal oxides may be used without departing from the present invention. The dimensions of the test model cylindrical vacuum chamber 30 are 10 cm in diameter and 61 cm long. However, other dimensions may be used without departing from the present invention.

X-rays are generated during the operation of the neutron/proton source 10 from Brensteshlung emission and by stray electrons striking metallic parts of the device. Because glass does not attenuate X-rays well, added lead shielding should be used to provide X-ray attenuation. However, only a thin layer of lead is necessary because X-rays are easily attenuated. X-ray attenuation can also be provided by any high-z material, such as ceramic, or by using leaded glass to make the cylindrical vacuum chamber 30.

Two anodes that are 100% transparent to oscillating particles 70 and 80 are located at either end of the cylindrical vacuum chamber 30 having axes coincident with the axis of the cylindrical vacuum chamber 30. In the preferred embodiment, the two anodes 70 and 80 are substantially cylindrical and hollow anodes 90 and 100. In the test model, the cylindrical anodes 90 and 100 are 9 cm in diameter. However, another diameter may be used without departing from the present invention.

Reflectors 110 and 120 are located at either end of the cylindrical vacuum chamber 30 between the cylindrical anodes 90 and 100 and the ends of the cylindrical vacuum chamber 30, so that their centers lie on the axis of the cylindrical vacuum chamber 30. In the preferred embodiment, the reflectors 110 and 120 are concave reflecting dishes 130 and 140 whose concave surfaces face the center of the cylindrical vacuum chamber 30. The concave reflecting dishes 130 and 140 are electrically grounded. The focal length of the concave reflecting dishes 130 and 140 is set to obtain good electron microchannel formulation, i.e., approximately the distance to the mouth of the cathode.

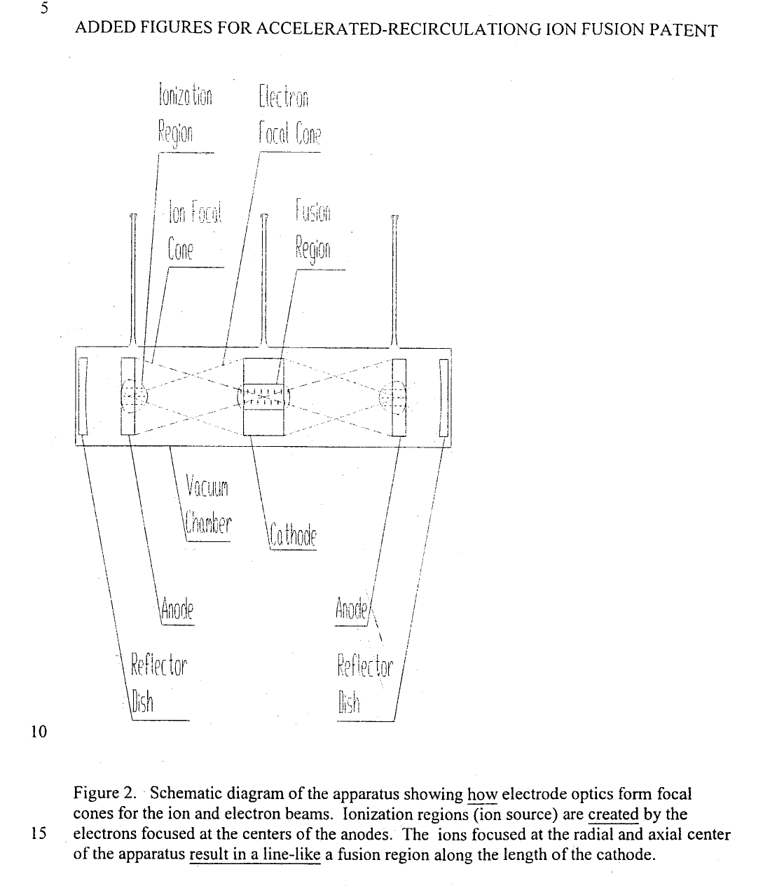

The guiding principles for the design of the electrode-charged particle optics in the apparatus are illustrated in FIG. 2. This figure shows how the position, spacing and length of the electrodes relative to their diameter determine ion and electron focusing properties. The hollow cylindrical electrodes result in contoured radial electric potential surfaces that create electrostatic lenses for the ion and electron beams passing through the surfaces. The length of an electrode relative to its diameter determines the electrostatic length (hence, particle trajectory focal cone) of the electrostatic lens. FIG. 2 illustrates how the desired electrode optics is designed to create focal cones for the ion and electron beams that, in turn, determine the ion source region and the fusion zone. The basic objective of the lens' design is to maximize electrostatic confinement of the ions while simultaneously providing a line-like region within the cathode where high energy ions can interact with background neutrals, and with themselves creating fusion neutrons or protons.

Ionization regions (i.e., the ion source regions) 300 and 301 are formed by designing the cathode 150 to focus passing electrons at the centers of the anodes. The anodes 70 and 80 are designed such that these ions are in turn focused at the radial and axial center of the apparatus, creating a fusion region 340 extending along the length of the cathode 150. The length of the fusion region can be varied by changing the length of the cathode 150, provided its diameter is correspondingly modified to maintain the desired electron focusing. Because the anodes share a common focal point, the ions passing them are confined until they are deflected out of the focal cones by scattering or charge exchange collisions.

In addition to ion confinement, it is necessary to confine electrons so that undesired space charge fields do not develop and degrade ion confinement. The electrostatic lenses created by the reflector dishes 110 and 120 and by the cathode 150 focus electrons near the radial center of the device at the anodes. The solid reflector dishes 110 and 120 are shaped with concave surfaces facing the center of the assembly to create an electrostatic reflection of electrons escaping from the ends of the anodes and focus them back within conical volumes 350 and 351 with their apexes at the center of the anodes. As noted earlier, relative to formation of the ionization zones 300 and 301, the cathode 150 forms a focal cone for electrons passing through it with foci at the center of the anodes 70 and 80 because with this focusing arrangement, the cathode and the reflector dishes share common focal points, and the electrons are confined until they ultimately scatter out of the respective focal cone regions. Thus, the overall effect of the design is to confine ions and electrons, providing multiple recirculation of the ions through the cathode where they can interact to produce the desired fusion neutrons or protons.

The preceding description provides an idealized description of electrode design and spacing such that the ions are confined in beams by pure electrostatic fields and self-inertia, providing the desired fusion region along the axis of the cathode. In practice, some small modifications of the dimensions found in this way are necessary to correct for nonideal effects such as fringe fields. Such design modifications are conveniently done using an ion trajectory tracking code.

The ion trajectory program, SIMION (G. H. Miley et al., “Accelerator Plasma-Target-Based Fusion Neutron Source.” Proceedings of4^{th} International Symposium on Fusion Nuclear Technology, Apr. 6-11, 1997, Tokyo, Japan), has been used extensively in present work to determine how the electrode configuration affects the ion trajectories. To illustrate these calculations and to further illustrate electrode lens design considerations, simulations employed to study the effect of changing the electrode diameter are briefly outlined here. The results show that the preferred configuration of the device described earlier is one of the best arrangements for ion focusing and confinement.

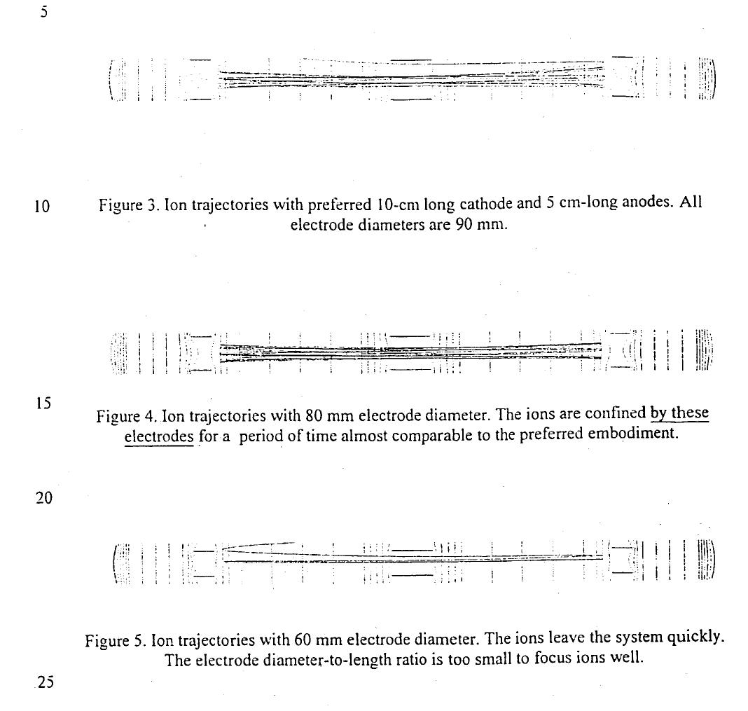

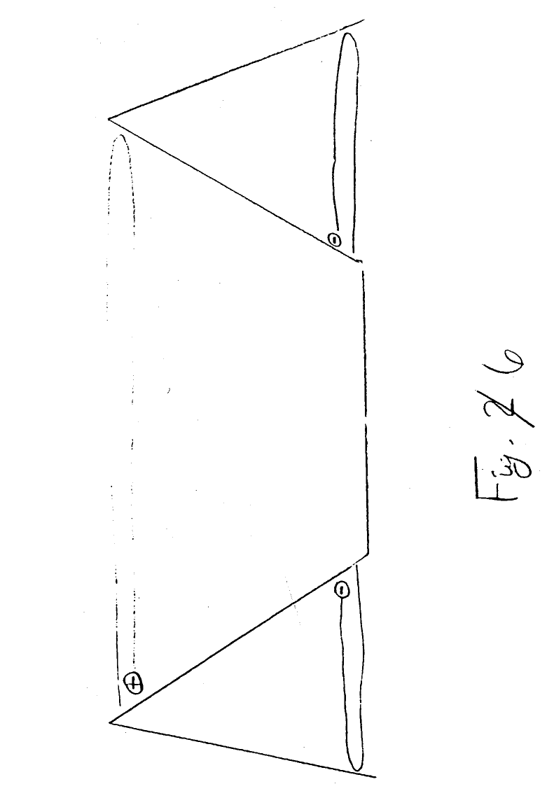

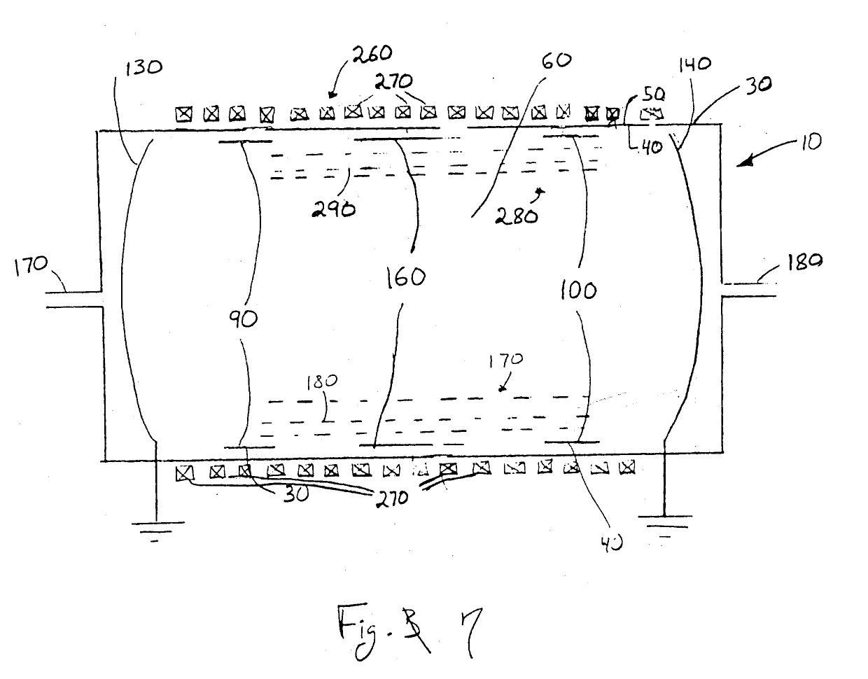

For reference, ion trajectory calculations using SIMION for the preferred embodiment are shown in FIG. 3. These results agree well with visual observations of ion beams in the experiment device which appear to focus in a rather tight beam entering the cathode. Subsequent simulations were performed with the diameter of all of the electrodes (anodes, reflector dishes, and cathode) reduced correspondingly. The lengths, positions, spacing and voltages of the electrodes were held constant at the preferred values for these simulations. When the electrodes were reduced to 80 mm in diameter, the ions remained well focused under the same conditions, as seen in FIG. 2. When the electrodes were reduced to 60 mm in diameter, the ions were not focused well and quickly left the system, as seen in FIG. 3. Thus, a minimum electrode diameter of 80 mm is indicated by these simulations, while the 90 mm diameter appears to be slightly better relative to confinement. i.e., offers more recirculations of the ions prior to their loss.

While simulations of this type have been found to agree reasonably well with experiments, SIMION includes a number of approximations, e.g., the neglect of electron and self-field effects. Thus, ultimately experimental studies are necessary for optimization of the neutron/proton yield. Variations in the cathode length and diameter are of particular interest in order to tailor the line-type neutron/proton source intensity and length. In that case, an important phenomenon not included in SIMION simulations that must be determined experimentally involves plasma sheath effects. Under normal operating conditions, a plasma sheath surrounds the inside surface of the cathode. This sheath leaves only a small region for a normal glow plasma to exist, where beam-beam or beam-background fusion can occur. The thickness of the plasma sheath is independent of the cathode diameter. Therefore, excessively decreasing the electrode diameter for a fixed length can cause the sheath to completely block normal glow plasma from reaching the center of the device. This in turn will prevent the formation of a single line neutron source and produce two less-efficient neutron sources on each side of the cathode.

In accordance with one aspect of the invention, and as seen in FIG. 2, this anode configuration allows electrons to oscillate inside a positive electric potential created by the cylindrical anodes 90 and 100 and the concave reflecting dishes 130 and 140, rather than being lost after ionization. This design serves six functions: (1) because the cylindrical anodes 90 and 100 are cylinders and their ends are uncovered, they are 100% transparent to oscillating particles (i.e. ions and electrons), and consequently, particle losses due to collisions of particles with the inner wall 40 of the cylindrical vacuum chamber 30 are reduced, thereby reducing overheating and erosion of the cylindrical anodes 30 and 40 due to direct particle-anode collisions, and allowing for better electron beam confinement; (2) it produces a more energy efficient system because the electrons have more opportunity to ionize neutral atoms, thereby creating more electron-ion pairs; (3) because the system is more energy efficient, the device may be operated at a lower pressure, which may help to reduce collisional loss; (4) the design causes an electron microchannelling effect, which in turn focuses ions into the microchannels, thereby creating good recirculating ion beam focusing; (5) the reduced loss of electrons leads to better charge balance in the system, which leads to better ion beam confinement; and (6) due to the high ion density in the ion beams, fusion reactions are enhanced.

In the test model, both the cylindrical anodes 90 and 100 and the concave reflecting dishes 130 and 140 are made of stainless steel. However, any material that can sustain a high temperature without much sputtering may be used. Tungsten has been found to be a good material, but it is expensive.

A cathode that is 100% transparent to oscillating particles 150 is centered in the middle of the cylindrical vacuum chamber 30 having the same axis as the cylindrical vacuum chamber 30 and the cylindrical anodes 90 and 100. In the preferred embodiment, the cathode 150 is a substantially cylindrical and hollow cathode 160, with a body that is solid throughout. In the test model, the cylindrical cathode 160 is made of stainless steel, and is 10 cm long and 9 cm in internal diameter. However, any material that can sustain a high temperature without much sputtering, such as Tungsten, and any other dimensions may be used without departing from the present invention. The cylindrical cathode 160 is electrically grounded. The role of the cylindrical cathode 160 is twofold. First, it is used to accelerate ions. Second, because the cylindrical cathode 160 is a cylinder and its ends are uncovered, it is 100% transparent to oscillating ions. This result reduces ion losses due to collisions of ions with the inner wall 40 of the cylindrical vacuum chamber 30, thereby reducing overheating and erosion of the cylindrical cathode 160 due to direct ion-cathode collisions, and allowing for better ion beam confinement.

A reactive gas is supplied to the cylindrical vacuum chamber 30 from an inlet 170 and discharged through an outlet 180. Preferably, the reactive gas used is a deuterium gas (for D-D reactions) or a mixture of deuterium and tritium gas. However, any other fusionable mixture, such as D-³He, may be used without departing from the present invention.

The outlet 180 is connected to a removable means for reducing the gas pressure 185 in the cylindrical vacuum chamber 30. In the test model, the removable means for reducing the gas pressure 185 is a turbo vacuum pump 190. Preferably, the cylindrical vacuum chamber 20 is initially pumped down to 10⁻⁷ Torr pressure by the turbo vacuum pump 190 and then backfilled with gas to 10⁻⁴ Torr. Other pressures may be used without departing from the present invention. However, as is well known to those skilled in the art, pressure varies with the voltage and the distance between the cathode and the anode. Thus, if the pressure is changed, either the voltage or the distance between the cylindrical cathode 160 and the cylindrical anodes 90 and 100 or both must be changed as well.

The reactive gas may either be slowly fed into the chamber with the turbo vacuum pump 190 valved down and running such that the desired pressure is maintained after the gas is added, or alternatively the cylindrical vacuum chamber 30 may be sealed off with the contained gas at the desired pressure and the turbo vacuum pump 190 removed, as is discussed later. For long-life operation of the sealed cylindrical vacuum chamber 30 configuration, special precautions may be employed to maintain gas pressure and purity, such as getters and internal gas reservoirs used in other sealed tube electronic devices.

A means for applying an electric potential 200 between the cylindrical anodes 90 and 100 and the cylindrical cathode 160 and the concave reflecting dishes 130 and 140 is supplied. In the test model, the means for applying an electric potential 200 is a positively biased, high voltage power supply 210 connected by feedthroughs 220 and 230 attached to connectors 240 and 250 extending through the wall of the cylindrical vacuum chamber 30 to the cylindrical anodes 90 and 100. However, other means for supplying an electric potential may be used without departing from the present invention.

The means for applying an electric potential 200 may supply one of two types of current: (1) a steady state current or (2) a pulsed current. The remainder of this description discusses the operation of the neutron/proton source 10 using a means for supplying an electric potential 200 that supplies a steady state current. However, a pulsed power supply may be used to obtain similar neutron yields as are achieved with steady state currents, but using less power. Preferably, a high voltage, low current steady-state power supply is first used to maintain a plasma discharge. A pulsed power supply connected to the appropriate electrodes then supplies pulses of current to the electrodes. This operation, as opposed to pulsing from a cold neutral gas condition, helps prevent arcing and enhances the ability to maintain a relatively constant voltage while the current is pulsed.

In one embodiment, the pulsed power supply is a unit composed of a capacitive storage with a fast switch. In the test model, a 2-μF capacitor was employed with a switch comprising a hydrogen thyration triggered by an SCR-capacitor circuit. However, other pulsed power supplies may be used without departing from the present invention.

The advantage of the pulsed power supply is that due to the current squared (or higher power) scaling of neutron yield, as discussed below, pulsed operation provides an improved neutron yield per time averaged input power. This principle is best illustrated by way of an example. Assume a 10⁹ n/s yield for D-D reactions is achieved using 100 kV of voltage and a 15-mA current, i.e., 1.5 kW steady-state current input power. Switching to a 10 Hz pulse rate using 10 μsec wide pulses with a peak pulse current of 15 A provides a larger peak neutron rate, but the same 10⁹ n/s time averaged rate calculated on the basis of I² scaling of the neutron rate during the pulse. However, this operation uses a time averaged input power of 100 kV×15 A×10⁻⁴=0.15 kW, where 10⁻⁴ represents the duty cycle, i.e., the fractional time that the pulses are “on.” Thus, the average power requirement is reduced by a factor of ten by using the pulsed power supply.

The improvement in power efficiency with pulsed operation increases as the pulse width is decreased. The repetition rate is increased and the duty cycle is decreased so as to achieve the maximum peak current during a pulse. The pulse width in time must, however, be longer than the ion recirculation time in order to preserve good ion confinement. The recirculation time, in turn, depends on the geometry of the neutron/proton source 10 and the operation conditions. The recirculation time for the test model operating under typical conditions is of the order of five (5) μsec. Thus, the ten (10) μsec pulse width used in the example above meets the parameters established for the test model. Large variations in the recirculation time may occur, however, without departing from the present invention.

In addition to the improved power efficiency achieved by the pulsed operation, a pulsed neutron source is desired for certain applications of the neutron/proton source. For example, some neutron activation analyses utilize measurements of characteristic decay gamma rays emitted from short half-life isotopes created when the pulse of neutrons irradiates the sample being investigated.

In operation using a steady state power supply, the cylindrical vacuum chamber 30 is initially evacuated to a low pressure by the turbo vacuum pump 190, and then backfilled with gas. Next, high positive voltage is biased to the cylindrical anodes 90 and 100. The gas pressure used depends on the operation voltage. This high voltage will cause gas breakdown, separating ions from electrons in neutral atoms. The separated ions and electrons are then accelerated by the cylindrical cathode 160 and cylindrical anodes 90 and 100 in opposite directions in the direction of the electric field created by the high voltage bias. The electrons are accelerated towards the cylindrical anodes 90 and 100, simultaneously colliding with neutral atoms, thereby producing additional electron-ion pairs. The electrons then oscillate within the positive potential wells created by the cylindrical anodes 90 and 100 and the concave reflecting dishes 130 and 140, ionizing still more neutral atoms and forming electron microchannels that help focus the ion beams.

The ions, on the other hand, are accelerated towards the cylindrical cathode 160, reaching maximum speed as they travel through the cylindrical cathode 160. After exiting the cylindrical cathode 160, the ions are decelerated and eventually reach a full stop before reaching the cylindrical anodes 90 and 100. Immediately following the full stop, they are accelerated again in the reverse direction toward the cylindrical cathode 160. In this fashion, the ions oscillate back and forth along electric field lines many times until they are scattered out of the system by interparticle collisions. The ions are also forced into ion beams by the electron microchannels, further raising the neutron yield.

During this oscillation, the ions reaching a sufficiently high speed will collide and fuse with neutral atoms and with other oscillating ions, producing neutrons. At the same time, the ions ionize background gas, producing secondary electrons. These electrons follow the same pattern as the electrons previously discussed. If deuterium gas is used, energetic neutrons are produced by D-D fusion reactions. If a mixture of deuterium and tritium gas is used, energetic neutrons are produced by D-T fusion reactions. Nonfusing ions either scatter or charge-exchange and eventually escape. The applied voltage, i.e., the ion speed, is selected to be near the energy corresponding to the maximum fusion cross-section, generally 50-200 kV, or higher if appropriate electrical insulation is incorporated.

The neutron yield per unit power input of the instant invention is greater than prior devices of this type because of the electron confinement in the positive potential wells, low ion loss, and good recirculating ion beam focusing. For higher ion currents (≧1 amp), yield can be expressed by the equation R ∝ I², where R is the neutron yield and I is the total recirculation ion-beam current. Experiments to date, briefly outlined in the next section, have achieved a neutron yield of 10⁶ n/s for D-D fusion reactions (equivalent to 10⁸ n/s for D-T reactions) using 60 kV and 20 mA. However, theoretical calculations indicate that for larger power inputs (i.e. 100 kV and 1.5A), the neutron yield can rise as high as 10¹³ neutrons/second for D-D fusion reactions, and 10¹⁵ neutrons/second for D-T fusion reactions. Voltages up to 200 kV may be used with the instant invention, the limit set by the space required to insert appropriate insulating materials, which prevent arcing. In operation, the user sets the voltage to achieve the maximum fusion cross section (i.e. 200 kV). Then, the user increases the current to achieve the maximum neutron yield. As discussed earlier, a pulsed power supply can achieve the same time averaged neutron yield as with a steady state power supply, but use less input power in the process.

Because fusion neutrons are emitted and little material intercepts them prior to leaving the chamber, a nearly monoenergetic source in energy is obtained, centered around 2.5 MeV if deuterium fill gas is used, and 14 MeV if the deuterium-tritium mixture is employed. Due to the larger fusion cross section for deuterium and tritium, neutron emission rates for this device will be about two orders of magnitude higher than for an equivalent deuterium device with the same power input. However, the use of radioactive tritium poses the added complication of requiring radiation protection licensing for its use.

A neutron/proton source 10 with an alternate geometry, such as a rectangular geometry, may be employed without departing from the present invention. Likewise, the axial shape of the neutron/proton source 10 and its components may vary without departing from the present invention. For example, the cylindrical anodes 90 and 100 can have a larder diameter than the cylindrical cathode 160.

### Operational Results and Prototypes

A prototype unit of the cylindrical IEC device has been run extensively to verify operational characteristics. Both steady-state and pulsed operation have been studied. The initial results are briefly outlined here.

Steady State Experiments

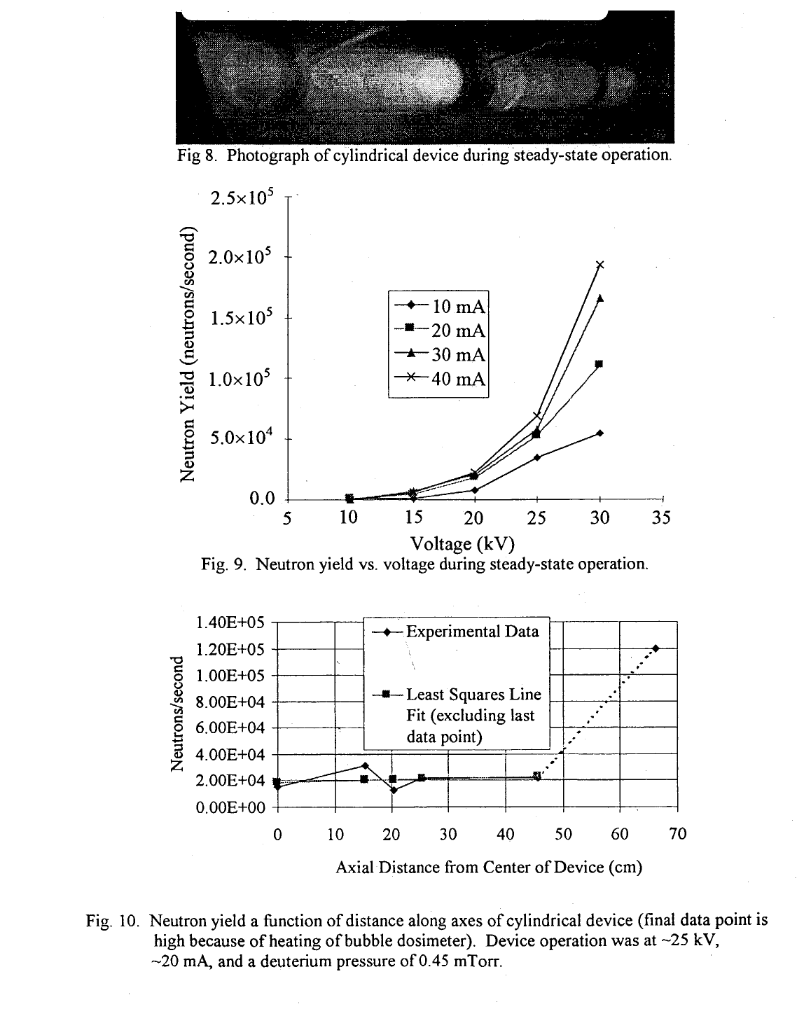

During steady state runs at voltages of 10-30 kV and currents of 10-40 mA, the cylindrical device demonstrated cylindrical IEC focusing as predicted theoretically. The beams are visible in the photograph of the device during operation shown in FIG. 8.

Neutron measurements were performed using a BF₃ neutron detector tube and pressurized bubble detectors. The BF₃ neutron detector was used for total neutron yield measurements during steady-state operation and the bubble detectors were used for neutron source distribution measurements. The neutron yield (neutrons/sec steady state) vs. applied voltage for various currents is shown in FIG. 9.

As seen in the figure, the neutron yield scales with the fusion cross section as a function of voltage resulting in an almost exponential increase in neutron yield with applied voltage. The yield increases linearly with current, but begins to follow a function of the current squared at higher currents. As discussed in connection with pulsed operation, this provides a strong motivation for development of a pulsed version for high-yield neutron operation.

To verify the line-like characteristic of the neutron source, measurements were made along the length of the cylinder using bubble dosimeters and results are shown in FIG. 10. Bubble dosimeters use a superheated fluid suspended in a gel. When neutron pass through gel, they deposit some of their energy to the superheated fluid forming bubbles of gas. The number of bubbles is proportional to the number of neutrons that have passed through the dosimeter. The neutron source strength can be estimated by counting the number of bubbles in the bubble dosimeter. The bubble dosimeters used for this experiment were sensitive to fast neutrons only (i.e. thermal neutrons and x-rays had no effect). The bubble dosimeter, although-temperature compensated, is still somewhat sensitive to temperature. Due to heating as the measurement progressed, the last data point (taken at 66 cm) is spurious because of the elevated temperature of the bubble dosimeter.

While these measurements have considerable inaccuracy associated with them, they clearly demonstrate the general trend for a line-like neutron/proton source behavior.

Pulsed Operation

The pulsing technique developed for the prototype cylindrical IEC pulsed experiments was a transmission-line pulser. Transmission-line pulsers typically use a pulse forming network (PFN) to generate and shape pulses. A pulse transformer is used to isolate the pulsing system from the steady-state high voltage applied to the neutron source and increase the pulse voltage applied to the device.

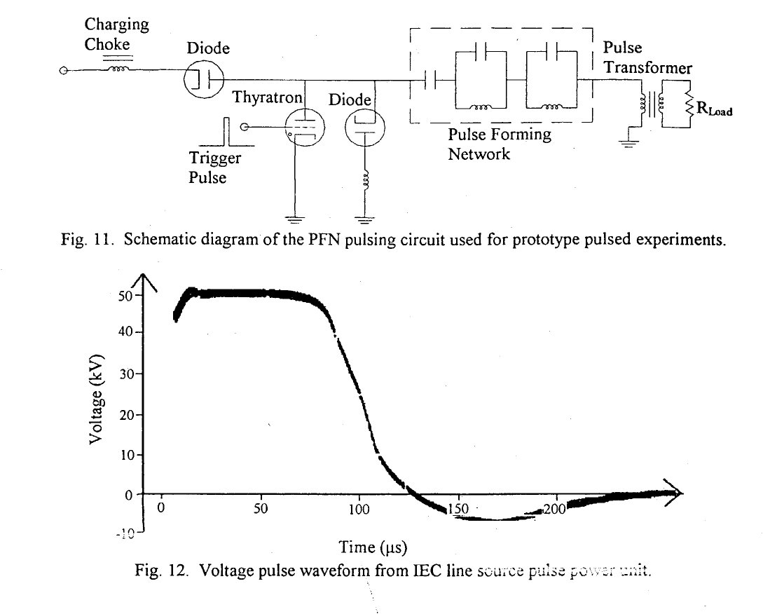

FIG. 11 shows a schematic of a transmission-line pulser circuit. The charging choke (an inductor or resistor) controls the charging rate of the PFN. The thyratron (an electric switch) discharges the positively charged energy-storage capacitor in the PFN to ground, generating a negative pulse in the primary windings of the pulse transformer. The pulse transformer steps up the pulse voltage to the level required by the load. The load in this case is the IEC line source plasma.

The voltage pulse waveform shown in FIG. 12 was generated by the IEC line source pulsed power unit described earlier. The peak voltage of this pulse is 50 kV. The corresponding current waveform has an identical shape except its peak magnitude is 5 A. These pulse characteristics are sufficient to provide a 10⁹ D-D neutron/sec line source when a pulse repetition rate of ˜100 pulses per second is used.

In conclusion, the pulse measurements have demonstrated the ability to develop a suitable pulsed power unit for use with the cylindrical neutron/proton source. This mode of operation will allow efficient high-yield neutron/proton operation for applications where that is desired. The steady-state version, however, still represents a very attractive unit for use in applications where high yields are not necessary.

### Energetic Proton Generation

The neutron/proton source 10 can be used as a proton generator after two slight modifications to the neutron/proton source 10. First, the gas used is D-³He, which produces high energy (approximately 14 MeV) protons and 3.5-MeV alpha particles. Next, the operating voltages are set slightly higher than that for the normal operation of the neutron/proton source 10 to approach the voltage equivalent to the energy at which the D-³He cross section peaks. The proton emission rate, however, will be close to the 2.5-MeV D-D neutron rate for an equivalent device with the same input power because the cross sections of D-³He and D-D are similar. This embodiment has the advantage that with straightforward changes in the gas and voltage, the neutron/proton source 10 can be used as 2.5-MeV or 14-MeV neutron source, or as a 14 MeV proton source.

### Commercial Version

For the purpose of producing the instant invention for sale to consumers, the cylindrical vacuum chamber 30 is initially evacuated to a low pressure, and then backfilled with gas. Next, the inlet 170 and outlet 180 are sealed airtight. The process of starting the fusion reaction within the cylindrical vacuum chamber 30 is then done by the purchaser of the instant invention. After the gas in the neutron/proton source 10 has been contaminated with impurities due to sputtering of materials, minute leaks and reaction products (after thousands of hours of usage), the neutron/proton source 10 may be shipped back to the manufacturer, who will again evacuate the cylindrical vacuum chamber 30, backfill it with gas, reseal the inlet 170 and the outlet 180, and send the neutron/proton source 10 back to the purchaser. The proton source would be handled in a similar fashion.

### Alternate Embodiment: Magnetically Assisted Focusing

In an another alternate embodiment of the instant invention, as shown in FIG. 3, a means for generating a magnetic field in the axial direction 260 is attached to the outer wall 50 of said cylindrical vacuum chamber 30. For the test model, the means for generating a magnetic field in the axial direction 260 is a plurality of magnetic rinses 270 encircling the outer wall 50 of the cylindrical vacuum chamber 30. Also for the test model, the magnetic rings 270 are permanent magnets with an outside radius larger than the inside radius of the cylindrical vacuum chamber 30. However, other magnets, such as electromagnets or superconducting magnets, and other dimensions may be used without departing from the present invention. The magnetic rings 270 are preferably placed next to one another with no distance between them in order to generate a uniform magnetic field 280. However, if the user wishes to save costs, the magnetic rings 270 may be spaced apart in order to use fewer rings.

The purpose of the magnetic rings 270 is to generate a magnetic field 280, which confines both ions and electrons in the radial direction. As a result, the loss rate of particles lost to the inner wall 40 of the cylindrical vacuum chamber 30 is reduced, thereby allowing for higher fusion reaction rates. The strongest magnetic field possible, given the practical problems of engineering the magnet into the system, is desirable. In the test model, the maximum field strength achievable using permanent magnets is approximately 4 kG. However, other types of magnets may generate higher field strengths.

Two types of magnetic fields 280 may be used with the present invention. The first is a shear B-field 290, which is essentially a surface magnetic field lying next to the inner wall 40 of the cylindrical vacuum chamber 30 in the axial direction, enclosing the cylindrical plasma column (i.e., the ion and electron beams viewed macroscopically). The shear B-field 290 has a large magnetic field gradient ΔB between the inner wall 40 of the cylindrical vacuum chamber 30 and the cylindrical plasma column. The shear B-field 290 provides a deflection force acting on all charged particles moving into it. Thus, both electrons and ions are forced away from the inner wall 40 of the cylindrical vacuum chamber 30 in a radial direction toward the cylindrical plasma column, thereby creating more particle collisions, which increases the fusion reaction rate. The force acting on a particle in the radial direction may be expressed as Fᵣ=−μΔB, where Fᵣ is the force in the radial direction and μ is the magnetic moment for the particle, which is proportional to the magnetic field gradient and points inward towards lower magnetic fields and the cylindrical plasma column.

The shear B-field 290 prohibits charged particles from leaving the system up to a specified energy Eₒ determined by the strength of the shear B-field 290. The confinement improvement can be evaluated in terms of T_{p loss}/Tₚ₋ₚ, the ratio of the average time for a charged particle to be lost due to upscattering (i.e., interparticle collisions that send particles in the radial direction) up to energy E_{o.} to the average scattering-collision time, the scale of which is equivalent to the confinement time by a pure electrostatic field. The ratio, as derived in R. H. Cohen et al., Nuc. Fusion 20, 1421 (1980) and P. J. Catto et al., Phy. Fluids 23, 352 (1985), may be expressed as T_{p loss}/Tₚ₋ₚ ∝ exp (Eₒ/E_{r,ave}) where E_{r,ave} is the average particle energy in the radial direction. When there is no magnetic confinement, Eₒ=0 and T_{p loss}/Tₚ₋ₚ=1. With the shear B-Field 180 added, T_{p loss}/Tₚₚ>1, indicating improved confinement. Using the shear B-field increases the efficiency (i.e., reaction rates per unit power) of the invention by approximately a factor of 5 in typical operation.

The second magnetic field type compatible with this embodiment is a homogeneous B-field (not shown), which is a magnetic field spread uniformly through out the cylindrical vacuum chamber 30 in the axial direction with a radial magnetic field gradient of zero. Instead of deflecting charged particles, the homogeneous B-field rotates the charged particles (ions/electrons) perpendicular to the homogeneous B-field, thereby slowing down the diffusion of particles, which increases the fusion reaction rate. The geofrequency of the rotation can be expressed as ω=qB/m, where B is the magnetic field strength, q is the charge and m is its mass. The radius of gyration is ρ=vᵣ/ω, where vᵣ is the angular velocity of the particles. The ratio of the diffusion with the homogeneous B-field to the diffusion without the homogeneous B-field, as derived in R. Papoular, Electrical Phenomena in Gases, 91 (1965), may be expressed as Dᵣ/Dₒ=1/(1+(ωT)²) for transverse (i.e., radial) diffusion, where T is the time interval between two successive collisions. Thus, the ion confinement is improved by the factor of (1+(TqB/m)²). The resulting improvement in efficiency appears to be less than for the shear B-field 290. This configuration may be desirable, however, for certain applications.

The two magnetically assisted IEC configurations described here are distinctly different from prior concepts for magnetically confirmed fusion devices. Thus, which there are some geometric similarities with the “electrostaitcally stoppered” mirror-type magnetic fusion unit disclosed by R. Hirsch (patent II . . . ), the confinement physics is entirely different. In the Hirsch device, the magnetic field is designed to be strongest at the ends (forming a magnetic “bottle” or “mirror”) in order to confine the ions and electrons. The electrostatic fields applied at the ends are intended to reduce leakage of ions that still manage to escape through the strong end-magnetic fields. In sharp contrast, in the present invention, ion and electron confinement is still achieved by the basic electrostatic fields created by the electrodes. The role of the superimposed field is to assist the electrode optical focusing by further tightening the ion beam diameter passing through the cathode region. This in turn reduces ion diffusion losses and increases the fusion reaction density, hence source intensity and overall efficiency for neutron/proton production.

1. An electrostatic accelerated-recirculating-ion fusion neutron/proton source, comprising:
a substantially cylindrical, axially elongated hollow vacuum chamber having an inner and outer wall;
a first cylindrical reflector and a second cylindrical reflector, said first and second reflectors having concave surfaces facing the longitudinal center of said axially elongated hollow vacuum chamber and disposed at and adjacent to opposite ends of said axially elongated vacuum chamber so that their centers lie on the axis of said vacuum chamber;
a hollow cylindrical cathode that is 100% transparent to oscillating ions and electrons within said vacuum chamber between said first and second reflectors, said cathode defining a central volume and having the same axis as said vacuum chamber;
a first hollow cylindrical anode and a second hollow cylindrical anode, said first and second anodes being 100% transparent to oscillating ions and electrons, said first anode disposed between said first reflector and said cathode and said second anode disposed between said second reflector and said cathode, where said first and second anodes have axes coincident with the axis of said vacuum chamber;
a nuclear fusible gas in said vacuum chamber wherein fusion reactions caused by collisions of ions produce neutrons and/or protons; and
means for applying an electric potential between said first and second anodes, said cathode and said first and second reflectors to produce ions and electrons from the nuclear fusible gas within said central volume, said cathode, anodes and reflectors functioning to electrostatically focus (i) said ions in a line-type fusion reaction region along the axis of the hollow cathode and (ii) said electrons in first and second electron collision-induced ionization regions within said first and second anodes, respectively,
wherein said ions and electrons oscillate back and forth along the axial direction of said vacuum chamber within the volume defined by the inside diameter of the central cathode and bounded on the ends by said first and second reflectors, said reflectors electrostatically reflect electrons escaping through said anodes and electrostatically refocus said electrons in a volume along the axis inside said anodes, and further wherein said oscillating ions and electrons aggregate into preferred paths in the background gas thereby reducing losses of ions and electrons due to transverse diversion of ions and electrons to the electrodes.

2. The neutron/proton source of claim 1, wherein said cathode is a thin walled, electrically conducting cylinder.

3. An electrostatic accelerated-recirculating-ion fusion neutron/proton source, comprising:
an axially elongated cylindrical vacuum chamber having an inner and outer wall;
first and second concave reflecting dishes, said first and second reflecting dishes disposed at and adjacent to opposite ends of said axially elongated vacuum chamber so that their concave surfaces face the center of said vacuum chamber and their centers lie on the axis of said vacuum chamber;
a cylindrical, solid, hollow cathode disposed within said vacuum chamber between said first and second reflecting dishes, wherein said cathode is 100% transparent to oscillating ions and electrons, defines a central volume and has the same axis as said vacuum chamber;
first and second cylindrical, hollow anodes that are 100% transparent to oscillating ions and electrons, wherein said first anode is disposed within said vacuum chamber between said first reflecting dish and said cathode, said second anode is disposed within said vacuum chamber between said second reflecting dish and said cathode, and said first and second anodes have axes coincident with the axis of said vacuum chamber;
a nuclear fusible gas in said vacuum chamber wherein fusion reactions caused by collisions between ions produce energetic fusion reaction products including neutrons and/or protons; and
means for applying an electric potential between said first and second anodes, said cathode and said first and second reflecting dishes to produce ions and electrons from the nuclear fusible gas within said central volume and to electrostatically focus said ions and electrons in regions along the axes of the cathode and anodes, respectively, said regions defined by the length-to-diameter ratios for the cathode and anodes and the spacing between the between the cathode and anodes,
wherein said ions and electrons oscillate back and forth along the axial direction of said vacuum chamber within the volume defined by the inside diameter of the central cathode and bounded on the ends by said first and second reflectors, said reflectors electrostatically reflecting and refocusing electrons in a volume along the axis inside said anodes, and further wherein said oscillating ions and electrons aggregate into preferred paths in the background gas thereby reducing losses of ions and electrons due to transverse diversion of ions and electrons to the electrodes.

4. The neutron/proton source of claim 3 further comprising means for controlling the gas pressure in said vacuum chamber.

5. The neutron/proton source of claim 4, wherein said means for controlling the gas pressure in said vacuum chamber comprises a gas feed inlet with a suitable pressure control valve and a turbo vacuum pump removably connected to said vacuum chamber.

6. The neutron/proton source of claim 3, wherein said vacuum chamber is made of an electrically non-conductive material.

7. The neutron/proton source of claim 3, wherein said means for applying an electric potential comprises a positively biased, high voltage power supply.

8. The neutron/proton source of claim 7, further comprising feedthroughs that attach said first and second anodes to said positively-biased, high voltage power supply.

9. The neutron/proton source of claim 7, wherein said positively-biased, high voltage power supply can provide a steady-state current and a pulsed current.

10. The neutron/proton source of claim 7, wherein said positively-biased, high voltage power supply provides a repetitive pulse current at a preset repetition rate.

11. The neutron/proton source of claim 3, wherein said means for applying an electric potential applies a positive potential between 10 kV and 200 kV.

12. The neutron/proton source of claim 3, wherein said nuclear fusible gas is selected from the group of gases consisting of deuterium, a mixture of deuterium and tritium, and a mixture of deuterium and Helium-3.

13. The neutron/proton source of claim 3, further comprising a means for generating a magnetic field in the axial direction attached to the circumference of said vacuum chamber.

14. The neutron/proton source of claim 13, wherein said means for generating a surface magnetic field is a plurality of magnetic rings.

15. The neutron/proton source of claim 13, wherein said magnetic field enhances electrostatic confinement to decrease ion/electron radial diffusion losses.

16. The neutron/proton source of claim 13, wherein said magnetic field enhances electrostatic focusing to increase the fusion reaction rate density in the fusionfusuin reaction zone within the hollow cathode.

17. The neutron/proton source of claim 14, wherein said means for generating a surface magnetic field is a plurality of permanent magnets.

18. The neutron/proton source of claim 14, wherein said means for generating a magnetic field is an electromagnet.

19. The neutron/proton source of claim 14, wherein said means for generating a magnetic field is a plurality of superconducting magnetic coils.

20. The neutron/proton source of claim 13, wherein said magnetic field is effectively a surface magnetic field lying next to said inner wall of said vacuum chamber.

21. The neutron/proton source of claim 20, wherein said surface magnetic field has a large magnetic field gradient extending into said vacuum chamber.

22. The neutron/proton source of claim 13, wherein said magnetic field is a homogeneous magnetic field spread uniformly throughout said vacuum chamber.

23. The neutron/proton source of claim 22, wherein said homogeneous magnetic field has a radial magnetic field gradient of about 10%.

24. An electrostatic accelerated-recirculating-ion fusion neutron/proton source, comprising:
an axially elongated cylindrical, non-electrically conductive vacuum chamber;
[first and second concave reflecting dishes, said first and second reflecting dishes disposed at and adjacent to opposite ends of said vacuum chamber so that their concave surfaces face the center of said vacuum chamber and their centers lie on the axis of said vacuum chamber;]
a cylindrical, solid, hollow cathode disposed within said vacuum chamber between said first and second reflecting dishes, wherein said cathode is 100% transparent to oscillating ions and electrons, defines a central volume and has the same axis as said vacuum chamber;
first and second cylindrical, hollow anodes that are 100% transparent to oscillating ions and electrons, wherein said first anode is disposed within said vacuum chamber between said first reflecting dish and said cathode, said second anode is disposed within said vacuum chamber between said second reflecting dish and said cathode, and said first and second anodes have axes coincident with the axis of said vacuum chamber;
first and second concave reflecting dishes for electrostatically reflecting and refocusing electrons in a volume along the axis inside said anodes, said first and second reflecting dishes disposed at and adjacent to opposite ends of said vacuum chamber so that their concave surfaces face the center of said vacuum chamber and their centers lie on the axis of said vacuum chamber;
a nuclear fusible gas in said vacuum chamber wherein fusion reactions caused by collisions of ions produce neutrons and/or protons;
a turbo vacuum pump removably connected to the vacuum chamber;
a positively-biased, high voltage power supply;
feedthroughs attaching said anodes to said positively-biased, high-voltage power supply; and
wherein said cathode and anodes electrostatically focus said ions and electrons in regions along the axes of the cathode and anodes, respectively, wherein said ions and electrons oscillate back and forth along the axial direction of said vacuum chamber within the volume defined by the inside diameter of the central cathode and bounded on the ends by said first and second reflectors and further wherein said oscillating ions and electrons aggregate into preferred paths in the background gas thereby reducing losses of ions and electrons due to transverse diversion of ions and electrons to the electrodes.

25. The neutron/proton source of claim 24, wherein said positively-biased, high voltage power supply can provide aprovidea steady-state current and/or a pulsed current.

26. The neutron/proton source of claim 24, wherein said positively-biased, high voltage power supply provides a repetitive pulse current at a preset repetition rate.

27. The neutron/proton source of claim 24, wherein said means for applying an electric potential applies a positive potential between 50 kV and 200 kV.

28. The neutron/proton source of claim 24, wherein said nuclear fusible gas is selected from the group of gases consisting of deuterium, a mixture of deuterium and tritium, and a mixture of deuterium and Helium-3.

29. The neutron/proton source of claim 24, further comprising a means for generating a magnetic field in the axial direction attached to the circumference of said vacuum chamber.

30. The neutron/proton source of claim 29, wherein said means for generating a surface magnetic field is a plurality of magnetic rings.

31. The neutron/proton source of claim 29, wherein said means for generating a surface magnetic field is a plurality of permanent magnets.

32. The neutron/proton source of claim 29, wherein said means for generating a magnetic field is an electromagnet.

33. The neutron/proton source of claim 29, wherein said means for generating a magnetic field is a plurality of superconducting magnetic coils.

34. The neutron/proton source of claim 29, wherein said magnetic field is effectively a surface magnetic field lying next to said inner wall of said vacuum chamber.

35. The neutron/proton source of claim 34, wherein said surface magnetic field has a large magnetic field gradient extending into said vacuum chamber.

36. The neutron/proton source of claim 29, wherein said magnetic field is a homogeneous magnetic field spread uniformly throughout said vacuum chamber.

37. The neutron/proton source of claim 36, wherein said homogeneous magnetic field has a radial magnetic field gradient of about 10%.

38. The neutron/proton source of claim 5 wherein said means for controlling the gas pressure in said vacuum chamber comprises a gas getter system whereby said gas pressure in said vacuum chamber can be maintained for extended periods with said pressure control valve closed.

39. The neutron/proton source of claim 5 wherein said means for controlling the gas pressure in said vacuum chamber comprises a gas-tight reservoir whereby said hydrogen isotope gas partial pressure in said vacuum chamber can be maintained and unwanted gas species may be permanently sorbed into the reservoir material for extended periods with said vacuum chamber sealed for operation without the support of mechanical pumpspressure control valve closed.
